(19) United States
(12) Patent Application Publication
(10) Pub. No.: US 2026/0086324 A1
(43) Pub. Date: Mar. 26, 2026

(54) OPTICAL DEVICE

(71) Applicant: GUANGZHOU LUXVISIONS INNOVATION TECHNOLOGY LIMITED, Guangzhou City (CN)

(72) Inventor: Tzu-Yao Lin, Guangzhou City (CN)

(73) Assignee: GUANGZHOU LUXVISIONS INNOVATION TECHNOLOGY LIMITED, Guangzhou City (CN)

(21) Appl. No.: 19/201,948

(22) Filed: May 8, 2025

Related U.S. Application Data
(60) Provisional application No. 63/699,765, filed on Sep. 26, 2024.

(30) Foreign Application Priority Data
Feb. 6, 2025 (CN) 202510133782.4

(51) Int. Cl. G02B 13/00; G02B 1/02; G02B 3/00; G02B 3/02; G03B 15/05

(52) U.S. Cl. CPC G02B 13/0025; G02B 1/02; G02B 3/02; G02B 13/0055; G02B 2003/0093; G02B 2207/101; G03B 15/05; G03B 2215/0567; G03B 2215/0592

(57) ABSTRACT

An optical device including a light source, a substrate, and a structured lens is provided. The light source is configured to emit a beam. The substrate is located on a light path of the beam. The structured lens is located on the light path of the beam and disposed at a light incident surface of the substrate. Here, the structured lens has a plurality of nanostructures configured to focus the beam.

### CROSS-REFERENCE TO RELATED APPLICATION

This application claims the priority benefit of U.S. provisional application Ser. No. 63/699,765, filed on Sep. 26, 2024 and China application serial no. 202510133782.4, filed on Feb. 6, 2025. The entirety of each of the above-mentioned patent applications is hereby incorporated by reference herein and made a part of this specification.

### BACKGROUND

### Technical Field

The disclosure relates to an optical device.

### Description of Related Art

When taking a photograph, using a flash to enhance background brightness is a common practice. Conventional flash lenses are typically designed to effectively focus light emitted by a light source onto the subject, ensuring sufficient illumination. In addition, some flash lenses incorporate diffusion functions and allow light to spread evenly to minimize strong shadows and bright spots, thereby enhancing image quality. However, when the conventional flash lenses are applied to compact portable devices, such as mobile phones, due to large size and high weight of the lenses, the overall system performance and user experience can be negatively impacted.

### SUMMARY

Some embodiments of the disclosure provide an optical device which includes a light source, a substrate, and a structured lens. The light source is configured to emit a beam.

The substrate is located on a light path of the beam. The structured lens is located on the light path of the beam and disposed at a light incident surface of the substrate. Here, the structured lens has a plurality of nanostructures configured to focus the beam.

### BRIEF DESCRIPTION OF THE DRAWINGS

FIG. 1 is a schematic diagram illustrating an optical device according to an embodiment of the disclosure.

FIG. 2A is a schematic diagram illustrating a substrate and a structured lens of an optical device according to an embodiment of the disclosure.

FIG. 2B is a top diagram illustrating a substrate and a structured lens of an optical device according to an embodiment of the disclosure.

FIG. 3 is a phase distribution diagram of an optical device according to an embodiment of the disclosure.

FIG. 4A is a diagram illustrating a relationship between a phase and a height of a cylinder according to an embodiment of the disclosure.

FIG. 4B is a diagram illustrating a relationship between the phase and a diameter of the cylinder according to an embodiment of the disclosure.

FIG. 5A and FIG. 5B are curve diagrams illustrating aberration characteristics of an optical device according to an embodiment of the disclosure.

FIG. 6A to FIG. 6E are diagrams illustrating a relationship between an optical transfer function (OTF) and a spatial frequency of an optical device according to an embodiment of the disclosure at different visual ranges.

FIG. 7A and FIG. 7B are curve diagrams illustrating aberration characteristics of an optical device according to an embodiment of the disclosure.

FIG. 8A to FIG. 8D are diagrams illustrating a relationship between an OTF and a spatial frequency of an optical device according to another embodiment of the disclosure at different visual ranges.

### DETAILED DESCRIPTION OF EMBODIMENTS

The embodiments are described in detail below with reference to the accompanying drawings but are not intended to limit the scope provided in the disclosure. In addition, component dimensions in the accompanying drawings are illustrated for convenience of explanation and are not drawn to actual scale. Moreover, although the terminologies such as “first,” “second,” and so on serve to describe different components and/or film layers, these components and/or film layers should not be limited by these terminologies. Rather, these terminologies simply serve to distinguish one component or film layer from another component or film layer. Therefore, the first component or film layer discussed below may be referred to as the second component or film layer without departing from the teachings of the embodiments. For ease of understanding, similar components in the following text will be indicated with the same reference numbers for explanation.

In the description of the embodiments of the disclosure, repeated reference numbers and/or terminologies may be used across different examples. These repetitions are intended for simplification and clarity and do not imply any limitation on the relationship between various embodiments and/or the described structural configurations. Besides, if this specification describes a first feature as being “on” or “above” a second feature, it encompasses embodiments where the first feature is in direct contact with the second feature, as well as embodiments where one or more additional features are interposed between them, such that the first and second features are not in direct contact. For ease of understanding, similar components in the following text will be denoted using the same reference numbers for explanation.

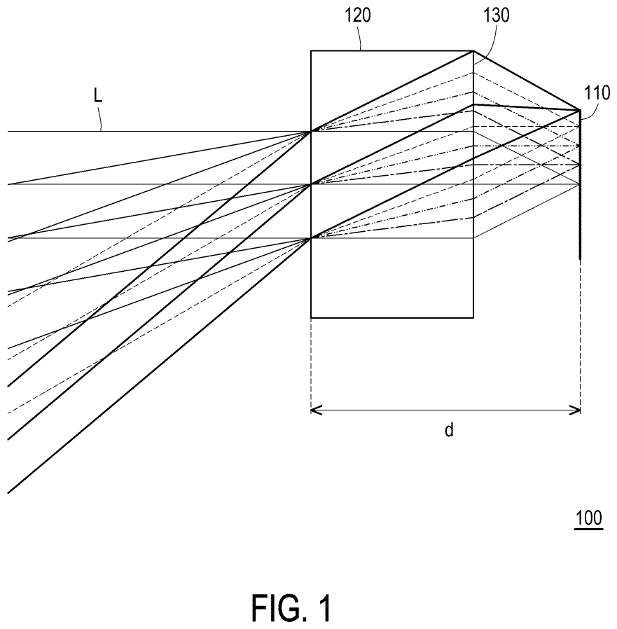

FIG. 1 is a schematic diagram illustrating an optical device according to an embodiment of the disclosure.

With reference to FIG. 1, an optical device 100 includes: a light source 110, a substrate 120, and a structured lens 130.

The light source 110 is configured to emit a beam L. In some embodiments, the light source 110 is a micro-LED array, for instance, a micro-LED array with a spacing of 2.6 mm, or something with similar functions, which should not be construed as a limitation in the disclosure. In some embodiments, a wavelength range of the beam L is 400-700 nm, which falls within the visible light range. In some embodiments, the beam L includes a monochromatic beam or a white beam, and the monochromatic beam includes a red beam, a green beam, or a blue beam.

The substrate 120 is located on a light path of the beam L. In some embodiments, the substrate 120 is a transparent substrate, for instance, a sapphire substrate, or something with similar properties, which should not be construed as a limitation in the disclosure.

The structured lens 130 is located on the light path of the beam L and disposed on a light incident surface of the substrate 120. The structured lens 130 has a plurality of nanostructures (not shown) configured to focus the beam L. The structured lens 130 provided in this embodiment, also known as a metalens, is an optical structure that controls amplitude, phase, and direction of light waves through nanostructures. Therefore, through the structured lens having the nanostructures, the amplitude, the phase, and the direction of the incident beam L can be changed to produce a beam that meets the requirements of practical applications.

In some embodiments, a distance from the light source 110 to the light incident surface of the substrate 120 is less than 3 mm, preferably 2 mm. In some embodiments, a thickness range of the substrate 120 is 2-3 mm, preferably 2.5 mm. In some embodiments, a distance from the light source 110 to a light output surface of the substrate 120 is less than 5 mm. Therefore, the total thickness of the optical device 100 is not greater than 5 mm, making it suitable for portable devices, for instance, the optical device 100 may be a flash light source for a mobile phone, a tablet computer, or any other similar device, which should however not be construed as a limitation in the disclosure.

A structure of the structured lens 130 is explained hereinafter.

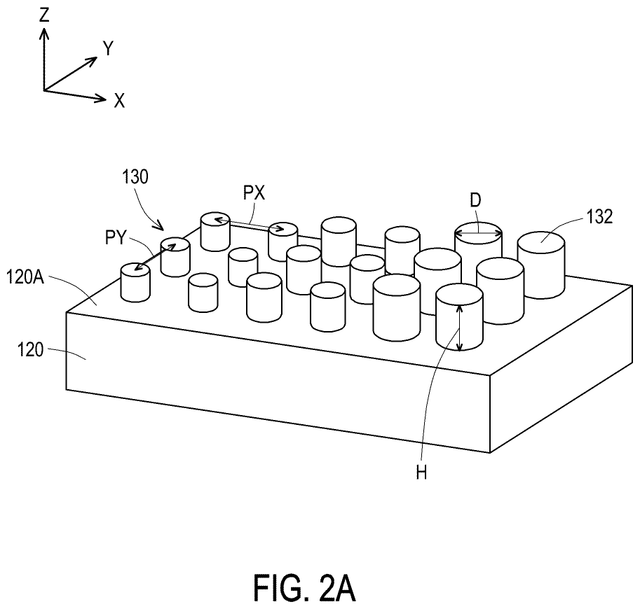

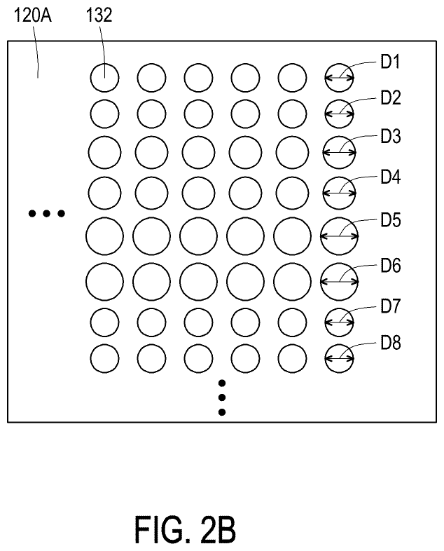

FIG. 2A is a schematic diagram illustrating a substrate and a structured lens of an optical device according to an embodiment of the disclosure.

With reference to FIG. 2A, the substrate 120 has a surface 120A. The surface 120A is the light incident surface of the substrate 120, and the beam L enters the substrate 120 through the surface 120A.

The structured lens 130 is disposed on the light incident surface 120A of the substrate 120. The structured lens 130 has a plurality of nanostructures 132 configured to focus the beam L.

In this embodiment, a material of the nanostructures 132 includes silicon nitride (Si₃N₄). When the beam L is incident to the nanostructures 132, through the displacement current generated when the silicon nitride interacts with the light waves, magnetic dipole resonance is induced, which can increase the interaction between the surface of the structured lens 130 and the light waves, enabling the surface of the structured lens 130 to cause a phase delay in the light waves, thereby changing the amplitude, the phase, and the direction of the incident beam L to produce a focusing effect on the incident beam L.

In addition, the silicon nitride has a refractive index (n) of 2 at the visible light wavelength of 632.8 nm and an extinction coefficient (k) of 0. Therefore, when the light source 110 that emits the beam L with the wavelength of 632.8 nm is selected, the structured lens 130 made of the silicon nitride as the nanostructures 132 can have a high refractive index (n) and does not absorb light at this wavelength, thus significantly reducing the energy loss of the beam L.

As shown in FIG. 2A, the nanostructures 132 are arranged in a simple cubic manner and arranged along a first direction X and a Y direction perpendicular to the first direction X. By controlling the spacing of the nanostructures 132, the optical properties of the structured lens 130 can be changed. Here, the spacing of the nanostructures 132 refers to the distance from a center point to another center point of adjacent nanostructures 132.

In this embodiment, the spacing range between the adjacent nanostructures 132 is 250-500 nm. Here, a spacing PX between the adjacent nanostructures 132 along the first direction X ranges from 250-500 nm, and a spacing PY between the adjacent nanostructures 132 along the second direction Y ranges from 250-500 nm. There may be another spacing based on actual application requirements, which should not be construed as a limitation in the disclosure.

In some embodiments, the spacing between the adjacent nanostructures 132 is equal. In other embodiments, the spacing between the adjacent nanostructures may be unequal.

As shown in FIG. 2A, the shape of the nanostructures 132 is cylindrical. Each of the nanostructures 132 has a diameter D and a height H, and by controlling the diameter D and the height H of each nanostructure 132, the optical properties of the structured lens 130 can be changed.

In this embodiment, the range of the height H of each of the nanostructures 132 is 300-1000 nm. In this embodiment, the nanostructures 132 include at least two heights. Therefore, by controlling the height H of each nanostructure 132, the optical properties of the structured lens 130 can be changed.

In this embodiment, the range of the diameter D of each of the nanostructures 132 is 100-300 nm. In this embodiment, the nanostructures 132 include at least two diameters. Therefore, by controlling the diameter D of each nanostructure 132, the optical properties of the structured lens 130 can be changed.

In this embodiment, each cylinder of the nanostructures 132 satisfies the following equation: 1<H/D<10, where H is the height of the cylinder, and D is the diameter of the cylinder. Through this equation, the shape of the cylinder can be defined, i.e., the height H of the cylinder is at least equal to the diameter D of the cylinder but not greater than ten times the diameter D.

Therefore, in summary, by changing the spacing PX, the spacing PY, the height H, and the diameter D of the nanostructures 132, the optical properties of the structured lens 130 can be changed.

FIG. 2B is a top diagram illustrating a substrate and a structured lens of an optical device according to an embodiment of the disclosure.

Please refer to FIG. 2B. FIG. 2B illustrates the distribution of the nanostructures 132 of the structured lens 130. As shown in FIG. 2B, the nanostructures 132 can have the same spacing but different diameters, e.g., a diameter D1=a diameter D2=100 nm, a diameter D3-a diameter D4=150 nm, a diameter D5=a diameter D6=300 nm, a diameter D7=a diameter D8=150 nm, and so on. By changing the diameters D of the nanostructures 132, the optical properties of the structured lens 130 can be changed.

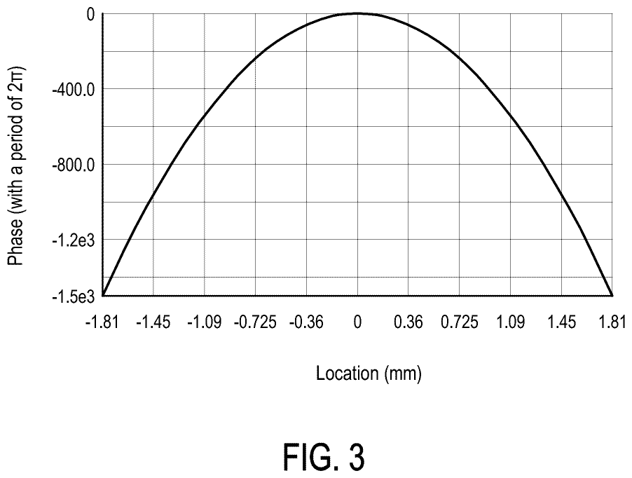

FIG. 3 is a phase distribution diagram of an optical device according to an embodiment of the disclosure. FIG. 3 illustrates the phase distribution at different positions on the surface of the structured lens 130. There is no phase change at a position 0, and different positions extend symmetrically along the left and right sides. Therefore, there are different phase distributions at different positions of the structured lens 130, whereby the optical properties of the incident beam L can be changed.

By changing the shape of the nanostructures 132 of the structured lens 130, the phase of the incident beam can be changed.

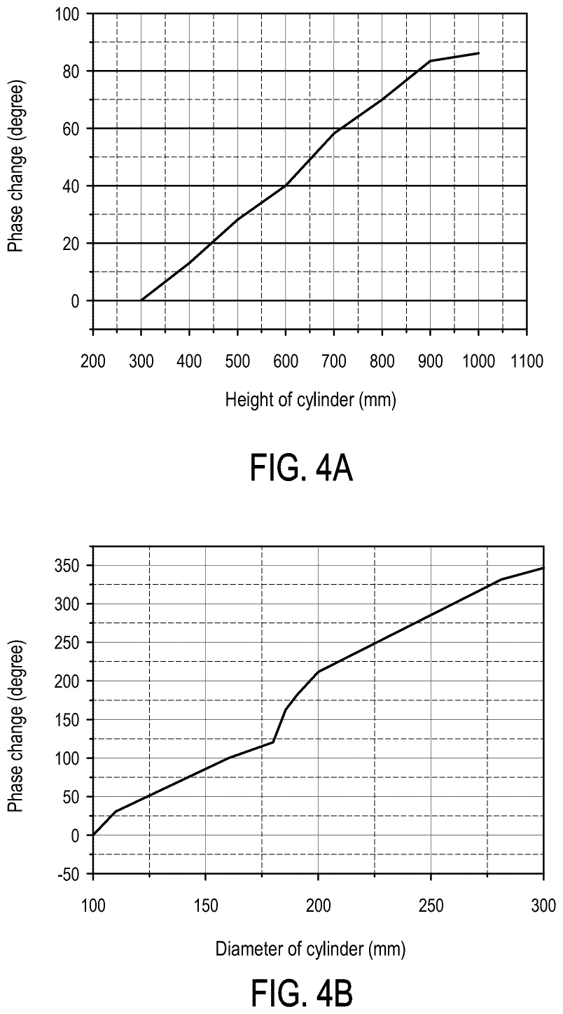

FIG. 4A is a diagram illustrating a relationship between a phase and a height of a cylinder according to an embodiment of the disclosure. FIG. 4B is a diagram illustrating a relationship between the phase and a diameter of the cylinder according to an embodiment of the disclosure. In some embodiments, a material of the nanostructures 132 includes silicon nitride, and the nanostructures 132 are shaped as cylinders. When the wavelength of the incident beam L is 632.8 nm, the refractive index (n) of the silicon nitride is 2, and the extinction coefficient (k) is 0.

Therefore, in the case of a fixed radius of the cylinder, the height of the cylinder and the corresponding phase delay are shown in FIG. 4A. When t the height of the cylinder gradually increases from 300 nm to 1000 nm, the phase delay can cover a range of 0-85 degrees. Therefore, by changing the height H of the cylinder of the nanostructures 132, precise phase delay control can be achieved, as shown in FIG. 4A.

On the other hand, in the case of a fixed height of the cylinder, the diameter of the cylinder and the corresponding phase delay are shown in FIG. 4B. When the diameter of the cylinder gradually increases from 100 nm to 300 nm, the phase delay can cover a range of 0-340 degrees. Therefore, by changing the diameter D of the cylinder of the nanostructures 132, precise phase delay control can be achieved, as shown in FIG. 4B.

By changing the characteristics of the nanostructures 132, the structured lenses 130 with different optical properties can be obtained.

In the optical device 100, there can be different implementation manners for complying with different requirements.

In the first embodiment, the optical device 100 has the following characteristics:

TABLE 1

| Wavelength | 400-700 | nm |
|---|---|---|
| Light source | 1.3 mm (the size of the | |
| dimension | micro LED panel is 2.6 mm) | |
| Field of view (FOV) | 80 | degrees |
| Effective focal | 2 | mm |
| length (EFL) | | |
| Through the lens (TTL) | 2.44 | mm |

| | |
|---|---|
| F/# | 1.7 |

In the first embodiment, the optical properties of the structured lens 130 can be equivalent to an aspherical lens, whose aspherical surface can be expressed by an equation 1.

$$Z = \frac{{cr}^{2}}{1 + \sqrt{1 - ( 1 + k ) {c}^{2} {r}^{2}}} + {A}_{2} {r}^{2} + {A}_{4} {r}^{4} + {A}_{6} {r}^{6} + {A}_{8} {r}^{8} + {A}_{10} {r}^{10} \qquad [ Equation 1 ]$$

In the equation 1, c is a reciprocal of a radius of curvature of the structured lens 130, k is a conic constant, r is a distance from any point on the aspherical surface to an optical axis, A₂, A₄, A₆, A₈, and A₁₀ are aspherical surface constants, and Z is a height in the optical axis direction from a point on the aspherical surface to the vertex of the corresponding aspherical surface.

Table 2 shows the optical properties of the optical device 100 according to the first embodiment, and Table 3 shows the lens characteristics and aspherical values of the structured lens 130 of the optical device 100 according to the first embodiment.

TABLE 2

| Surface | | | Radius of | Thickness | |
|---|---|---|---|---|---|
| No. | Surface | | curvature | (mm) | Material |
| S0 | Standard | Object | Infinity | 3.00E+3 | |
| S1 | Standard | Object | Infinity | 1.00E+1 | |
| S2 | Standard | | Infinity | −2.07E−7 | |
| S3 | Standard | Substrate | Infinity | 2.47 | Sapphire |
| | | 120 | | | |
| S4 | Binary | Structured | Infinity | 2.00 | |
| | surface | lens 130 | | | |
| S5 | Standard | | Infinity | 0.00E0 | |

TABLE 3

| Surface No. | S5 |
|---|---|
| K | 5 |
| A₂ | −1.14E6 |
| A₄ | 6.75E5 |
| A₆ | −8.93E7 |
| A₈ | 4.34E9 |
| A₁₀ | −4.06E10 |

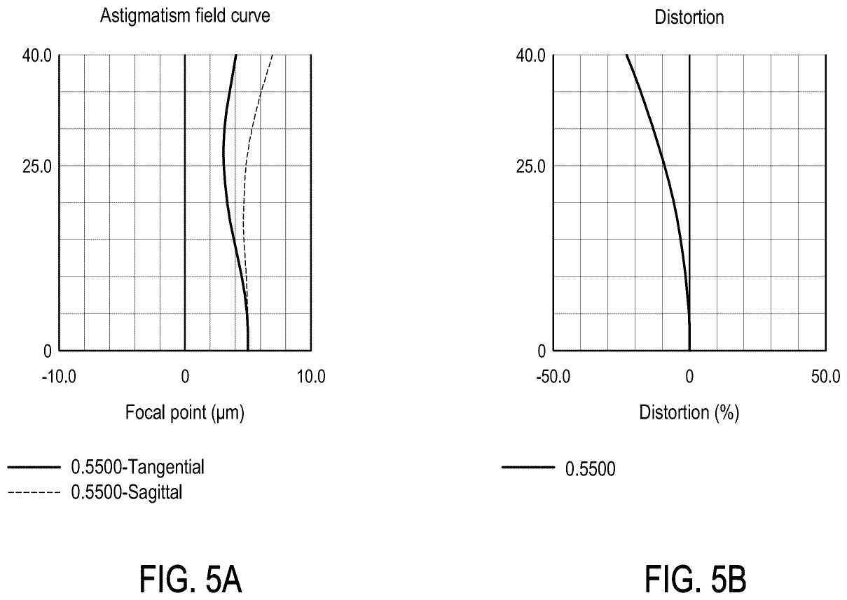

FIG. 5A and FIG. 5B are curve diagrams illustrating aberration characteristics of an optical device according to an embodiment of the disclosure. FIG. 5A is an astigmatism field curve showing a field curvature aberration in a tangential direction and a field curvature aberration in a sagittal direction when the wavelength of the incident beam is 550 nm. FIG. 5B is a distortion curve when the wavelength of the incident beam is 550 nm.

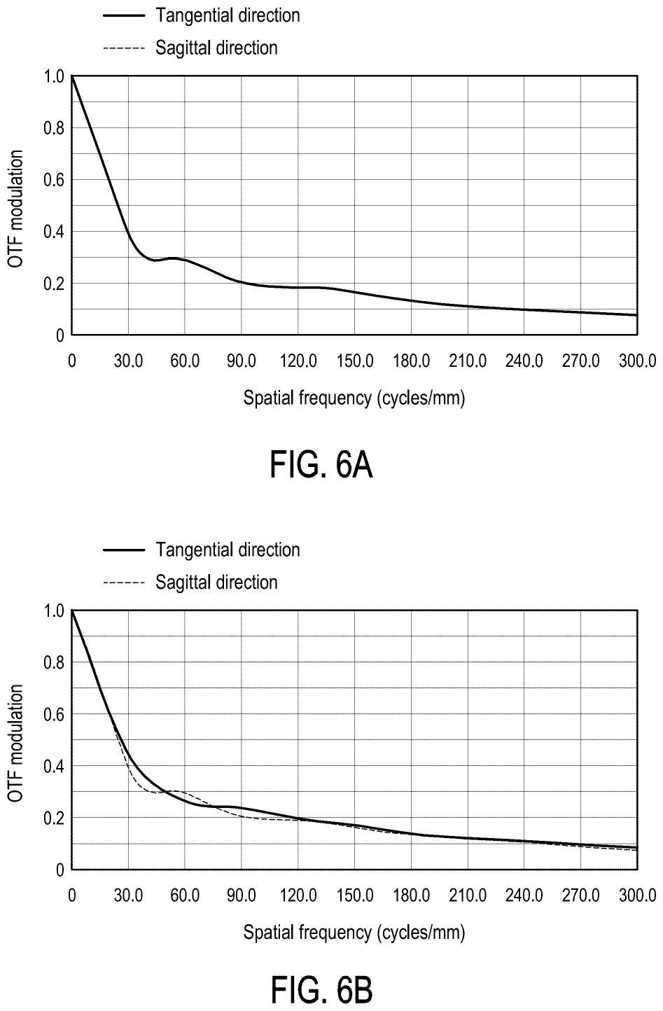

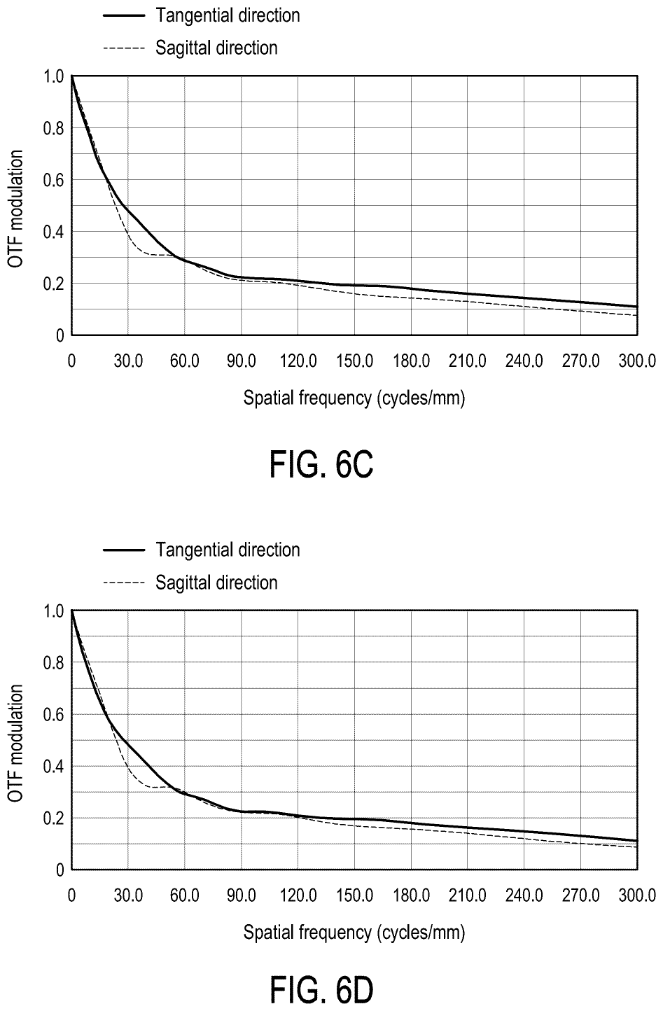

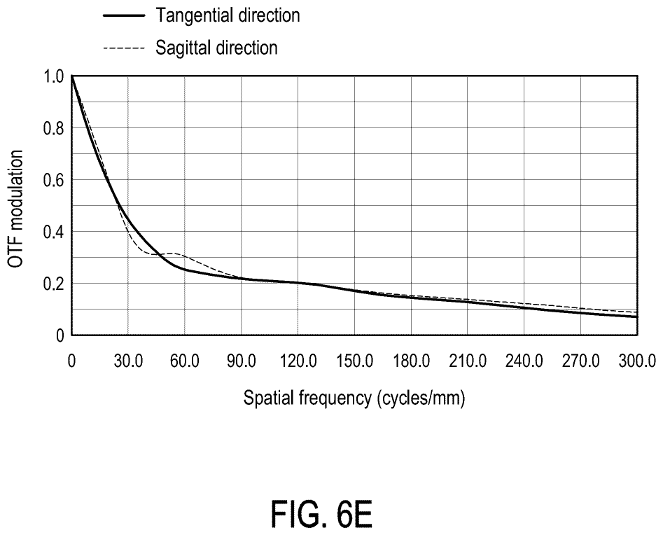

FIG. 6A to FIG. 6E are diagrams illustrating a relationship between an OTF and a spatial frequency of an optical device according to a first embodiment of the disclosure at different visual ranges. FIG. 6A to FIG. 6E respectively show the relationship between the OTF and the spatial frequency in the tangential direction and the sagittal direction when the FOV is 0 degree, 10 degrees, 20 degrees, 30 degrees, and 40 degrees.

The diagrams in FIG. 5A, FIG. 5B, and FIG. 6A to FIG. 6E are all within the standard range, thereby verifying that the optical device 100 provided in this embodiment can achieve good imaging effects.

In the second embodiment, the optical device 100 has the following characteristics:

TABLE 4

| Wavelength | 400-700 | nm |
|---|---|---|
| Light source | 1.06 mm (the size of the | |
| dimension | micro LED panel is 2.12 mm) | |
| FOV | 60 | degrees |
| EFL | 2 | mm |
| TTL | 3.5 | mm |

| | |
|---|---|
| F/# | 3.38 |

Compared to the first embodiment, the second embodiment has a smaller light source size, a smaller FOV, and a larger TTL, i.e., the thickness of the substrate 130.

In this second embodiment, the optical properties of the structured lens 130 can be equivalent to an aspheric lens, and its aspheric surface, as described in the first embodiment, can be expressed by the equation 1.

Table 5 shows the optical characteristics of the optical device 100 according to a second embodiment, and Table 6 shows the lens characteristics and aspheric values of the structured lens 130 of the optical device 100 according to the second embodiment.

TABLE 5

| Surface | | | Radius of | Thickness | |
|---|---|---|---|---|---|
| No. | Surface | | curvature | (mm) | Material |
| S0 | Standard | Object | Infinity | 3.00E+3 | |
| S1 | Standard | Object | Infinity | 1.00E+1 | |
| S2 | Standard | | Infinity | 4.69E−3 | |
| S3 | Standard | Substrate | Infinity | 1.5 | Sapphire |
| | | 120 | | | |
| S4 | Binary | Structured | Infinity | 2.00 | |
| | surface | lens 130 | | | |
| S5 | Standard | | Infinity | 0.00E0 | |

TABLE 6

| Surface No. | S5 |
|---|---|
| K | 5 |
| A₂ | −1.14E6 |
| A₄ | 2.26E7 |
| A₆ | 1.72E9 |
| A₈ | −1.30E12 |
| A₁₀ | −5.20E14 |

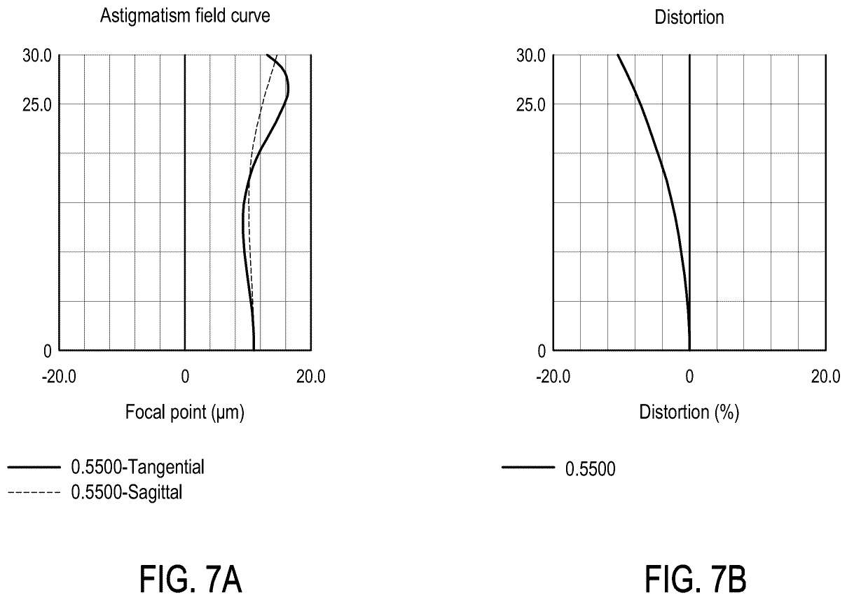

FIG. 7A and FIG. 7B are curve diagrams illustrating aberration characteristics of an optical device according to a second embodiment of the disclosure. FIG. 7A is an astigmatism field curve showing a field curvature aberration in a tangential direction and a field curvature aberration in a sagittal direction when the wavelength of the incident beam is 550 nm. FIG. 7B is a distortion curve when the wavelength of the incident beam is 550 nm.

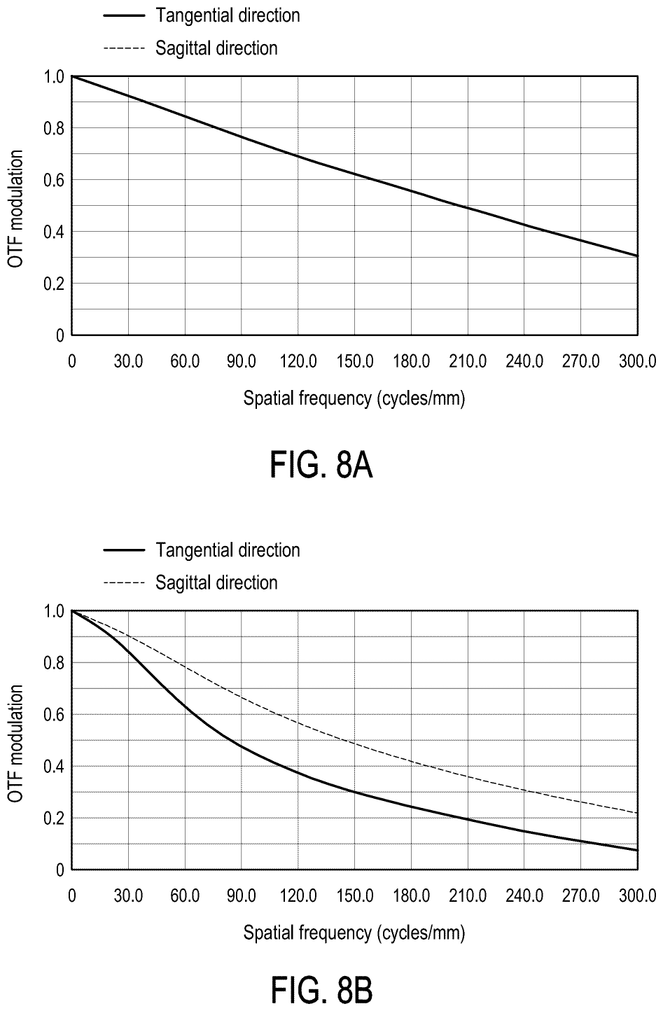

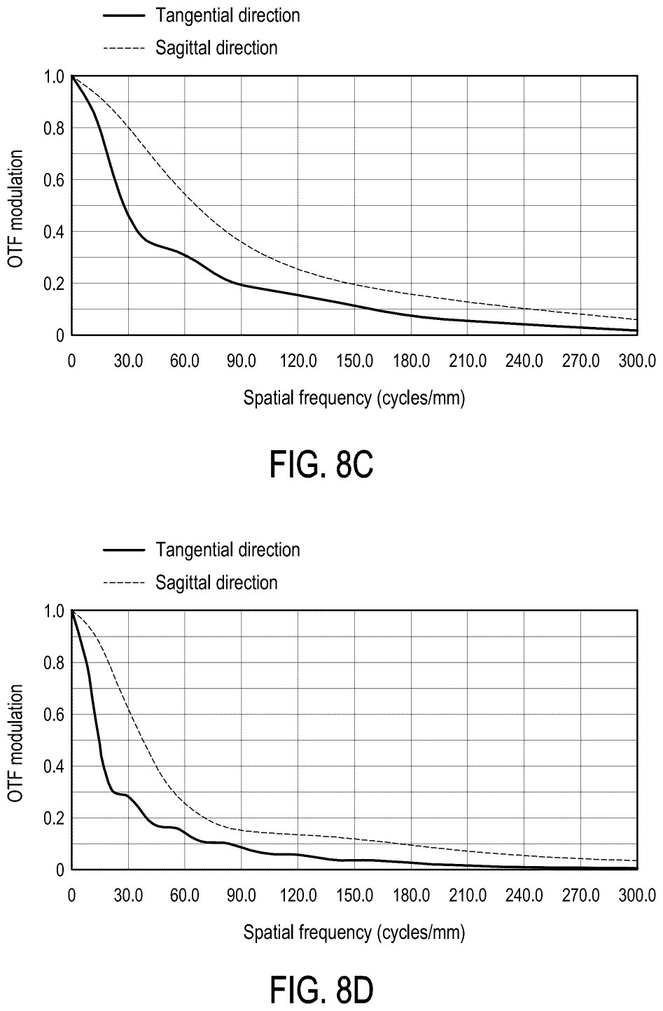

FIG. 8A to FIG. 8D are diagrams illustrating a relationship between an OTF and a spatial frequency of an optical device according to the second embodiment of the disclosure at different visual ranges. FIG. 8A to FIG. 8D respectively show the relationship between the OTF and the spatial frequency in the tangential direction and the sagittal direction at 0 degree, 10 degrees, 20 degrees, and 30 degrees.

The diagrams in FIG. 7A, FIG. 7B, and FIG. 8A to FIG. 8D are all within the standard range, thereby verifying that the optical device 100 provided in this embodiment can achieve good imaging effects.

In the first embodiment and the second embodiment, the FOV ranges from 50 degrees to 90 degrees, the TTL ranges 2 mm to 4 mm, and the EFL is 2 mm. Therefore, the characteristics of the optical device 100 can be diversified by adjusting the characteristics of the structured lens 130.

To sum up, according to one or more embodiments of the disclosure, applying the structured lens to the optical device significantly enhances the scattering effect of the beam, optimizes the uniformity and distribution of the light source, and thereby improves the light quality during photography. Specifically, the microstructure design of the structured lens effectively reduces reflection and flare phenomena, enhancing image clarity and realism. In addition, the structured lens offers advantages in size and weight compared to conventional lenses. Therefore, in one or more embodiments of the disclosure, the structured lens not only improves the overall performance of the flash lens, but also enhances the user's photography experience. Moreover, the optical device exhibits extensive potential for market applications.

Although the disclosure has been disclosed in the embodiments as above, it is not intended to limit the disclosure. Any person having ordinary knowledge in the art can make minor modifications and refinements without departing from the spirit and scope of this disclosure. Therefore, the protection scope of this disclosure shall be defined by the appended claims.

What is claimed is:

1. An optical device, comprising:
a light source, configured to emit a beam;
a substrate, located on a light path of the beam;
a structured lens, located on the light path of the beam and disposed at a light incident surface of the substrate, wherein the structured lens has a plurality of nanostructures configured to focus the beam.

2. The optical device according to claim 1, wherein a spacing between each pair of adjacent nanostructures of the nanostructures ranges from 250-500 nm.

3. The optical device according to claim 1, wherein a spacing between each pair of adjacent nanostructures of the nanostructures is all equal.

4. The optical device according to claim 1, wherein a height of each of the nanostructures ranges from 300-1000 nm.

5. The optical device according to claim 1, wherein the nanostructures comprise at least at least two different heights.

6. The optical device according to claim 1, wherein the nanostructures are cylinders.

7. The optical device according to claim 6, wherein a diameter of the cylinders ranges from 100-300 nm.

8. The optical device according to claim 6, wherein the cylinders satisfy an equation: 1<H/D<10, wherein H is a height of the cylinders, and D is a diameter of the cylinders.

9. The optical device according to claim 6, wherein the nanostructures comprise at least two different diameters.

10. The optical device according to claim 1, wherein a material of the nanostructures comprises silicon nitride.

11. The optical device according to claim 1, wherein the light source is a micro light emitting diode array.

12. The optical device according to claim 1, wherein a wavelength range of the beam is 400-700 nm.

13. The optical device according to claim 1, wherein the substrate is a sapphire substrate.
